(19) United States
(12) Patent Application Publication
(10) Pub. No.: US 2016/0180406 A1
(43) Pub. Date: Jun. 23, 2016

(54) COMBINED ADVERTISEMENTS

(71) Applicant: Yahoo!, Inc., Sunnyvale, CA (US)

(72) Inventors: Sudhir Chauhan, Sunnyvale, CA (US); Yogesh Kumar Agrawal, San Jose, CA (US); Shivakumar Ningappa, Milpitas, CA (US); Sundeep Narravula, Sunnyvale, CA (US); Ashutosh Kumar, Milpitas, CA (US)

(21) Appl. No.: 14/576,129

(22) Filed: Dec. 18, 2014

(51) Int. Cl. G06Q 30/02; H04L 29/08

(52) U.S. Cl. CPC G06Q 30/0276; H04L 67/02; G06Q 30/0269; G06Q 30/0242; G06Q 30/0275

(57) ABSTRACT

One or more systems and/or techniques for generating a combined advertisement are described herein. A primary advertisement associated with a primary advertiser may be accessed. A primary attribute for the primary advertisement may be defined (e.g., a car advertisement may target teenage boys). A first spot advertisement associated with a first advertiser may be selected based upon the primary attribute of the primary advertisement (e.g., a car tuning advertisement that also targets teenage boys). A combined advertisement may be generated based upon the first spot advertisement and the primary advertisement. In an example, the combined advertisement may be displayed to a consumer based upon a determination that the consumer corresponds to the primary attribute (e.g., a teenage boy visiting a website). In this way, multiple advertisements (e.g., having similar attributes/goals) may be provided through a single combined advertisement.

### BACKGROUND

Many content providers, applications, and/or websites provide advertisement opportunities. In an example, a video streaming content provider may provide video advertisement opportunities within a video content player interface. In another example, a website may provide imagery advertisement opportunities for display on the website. Advertisers may bid on advertisement opportunities as part of an advertisement campaign for marketing a product or service. A winning advertiser may acquire and utilize the advertisement opportunity such as to display an advertisement.

### SUMMARY

In accordance with the present disclosure, one or more systems and/or methods for generating a combined advertisement are provide herein. A primary advertisement, associated with a primary advertiser, may be accessed. A primary attribute for the primary advertisement may be defined (e.g., a target demographic for the primary advertisement). A first spot advertisement, associated with a first advertiser, may be selected based upon the primary attribute of the primary advertisement. In an example, the first spot advertisement, but not a second spot advertisement, may be selected based upon the first spot advertisement satisfying an exclusionary attribute and the second spot advertisement not satisfying the exclusionary attribute. A combined advertisement may be generated based upon the first spot advertisement and the primary advertisement. In an example, the generating the combined advertisement may comprise inserting the primary advertisement into a primary advertisement region of the combined advertisement and/or inserting the first spot advertisement into a secondary advertisement region of the combined advertisement. In an example, one or more additional spot advertisements may be selected for inclusion within the combined advertisement (e.g., for display through a carousel interface).

The combined advertisement may be displayed to a consumer based upon a determination that the consumer corresponds to the primary attribute of the primary advertisement. In an example, the combined advertisement may be displayed to the consumer in response to a consumer attribute of the consumer matching the primary attribute of the primary advertisement.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an exemplary configuration of a server that may utilize and/or implement at least a portion of the techniques presented herein.

FIG. 3 is an illustration of a scenario involving an exemplary configuration of a client that may utilize and/or implement at least a portion of the techniques presented herein.

FIG. 4 is a flow chart illustrating an example method for generating a combined advertisement.

FIG. 5A is a component block diagram illustrating an exemplary system for generating a combined advertisement based upon a first spot advertisement and a primary advertisement.

FIG. 5B is a component block diagram illustrating an exemplary system for generating a combined advertisement, where an advertisement template is formed.

FIG. 5C is a component block diagram illustrating an exemplary system for generating a combined advertisement, where the combined advertisement is formed based upon a template advertisement framework.

FIG. 5D is a component block diagram illustrating an exemplary system for generating a combined advertisement, where the combined advertisement comprises an advertisement carousel.

FIG. 5E is a component block diagram illustrating an exemplary system for generating a combined advertisement, where a spot advertisement is selected through a bidding process.

FIG. 6 is an illustration of a scenario featuring an exemplary nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware, or any combination thereof.

1. Computing Scenario

The following provides a discussion of some types of computing scenarios in which the disclosed subject matter may be utilized and/or implemented.

1.1. Networking

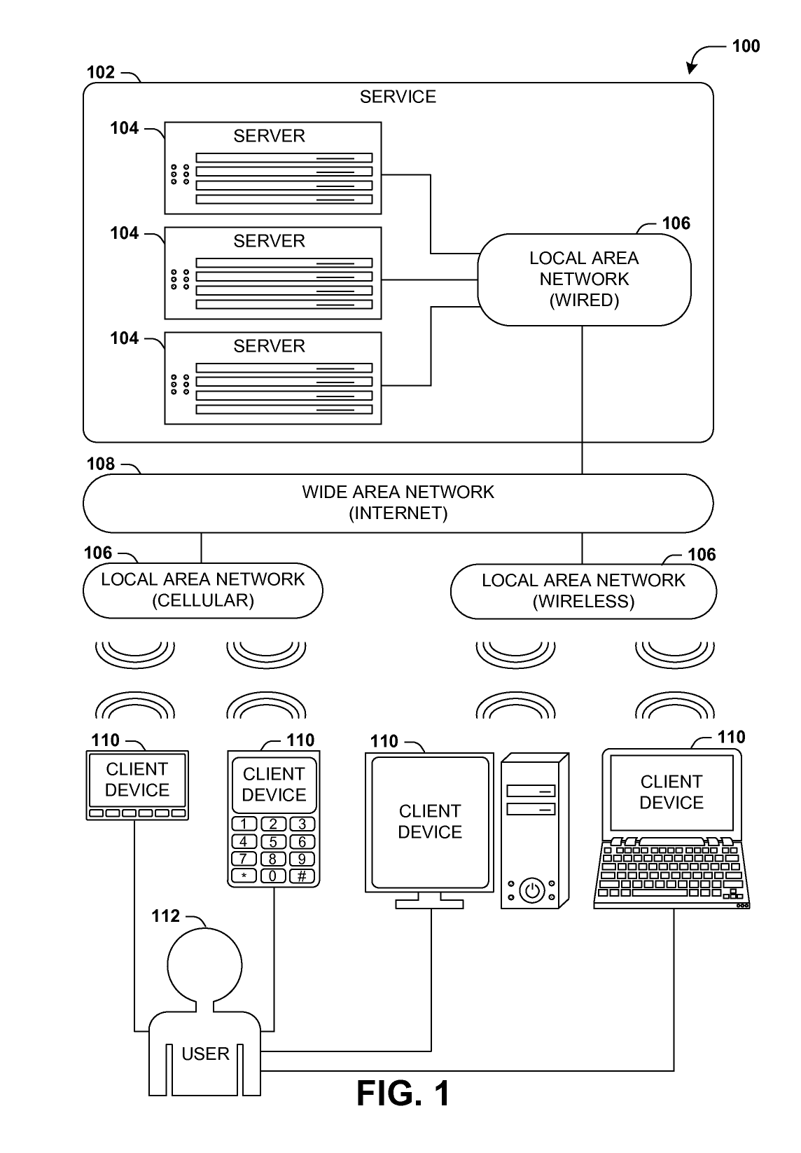

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols, and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a Wi-Fi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

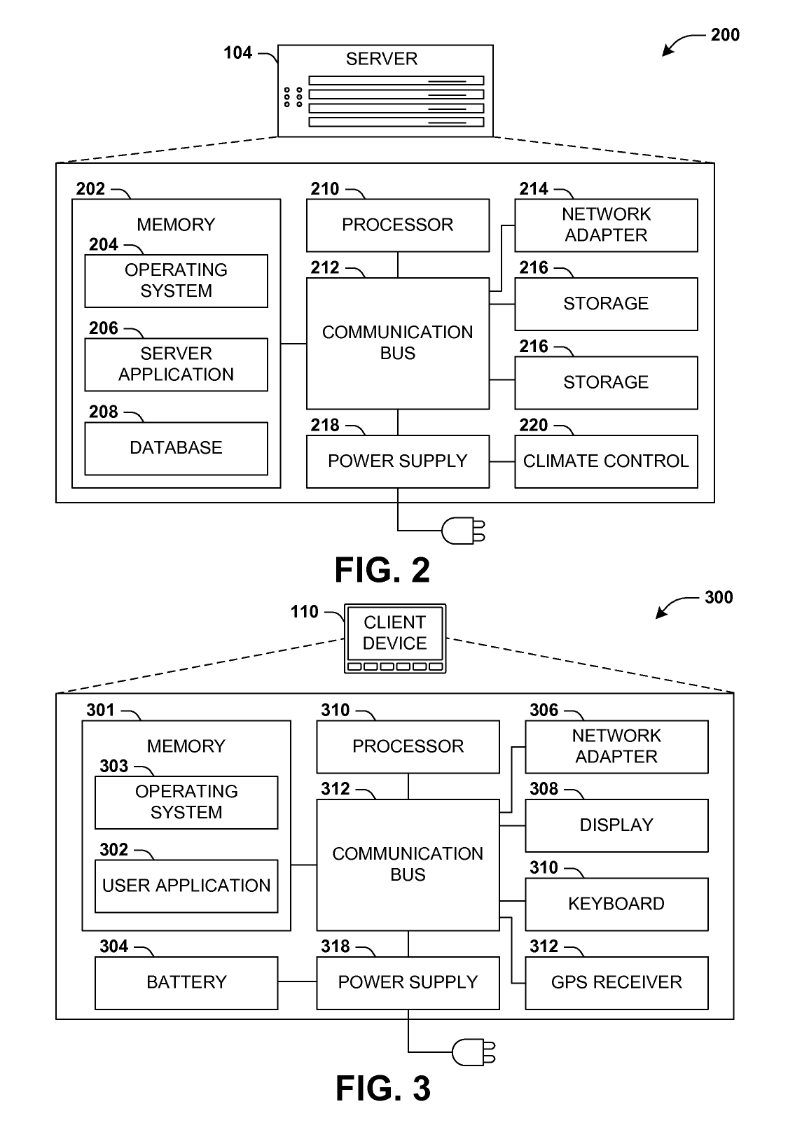

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more techniques and/or systems for generating a combined advertisement are provided herein. A combined advertisement may be created from multiple advertisements based upon advertisements that corresponds to primary attribute, such as a targeting attribute (e.g., a target audience for which an advertisement is to reach), a budget attribute, a creative attribute (e.g., a funny advertisement, a video advertisement, etc.), an exclusionary attribute (e.g., an exclusion of competitor advertisements), etc. In an example, a primary advertisement, associated with a primary advertiser, may be accessed (e.g., received by the primary advertiser). A primary attribute may be defined for the primary advertisement (e.g., the primary advertiser may specify the primary attribute or preferences used to define the primary attribute). The attribute of the primary advertisement may be used to select a spot advertisement, associated with a first advertiser, to combine with the primary advertisement to create a combined advertisement. In an example, the primary advertisement may be dynamically match to one or more spot advertisements having spot attributes that correspond to the primary attribute of the primary advertisement (e.g., the primary advertisement and the spot advertisement may both target consumers in the same age range, income bracket, geographic location, gender, etc.). In an example, an advertiser spot advertisement may be selected based upon a bid submitted by an advertiser of the spot advertisement (e.g., spot advertisers may bid on opportunities for being combined with primary advertisements).

In this way, a combined advertisement may be generated based upon the primary advertisement and the spot advertisement. In an example of generating the combined advertisement, the primary advertisement may be inserted into a primary advertisement region of the combined advertisement and/or the spot advertisement may be inserted into a secondary advertisement region of the combined advertisement. The secondary advertisement region may be configured to display one or more spot advertisements that are inserted into the secondary advertisement region (e.g., spot advertisements having spot attributes corresponding to the primary attribute of the primary advertisement and/or spot attributes of other spot advertisements contained therein). The combined advertisement may be displayed to a consumer, such as in response to a determination that the consumer has a consumer attribute that corresponds to the primary attribute of the primary advertisement and/or the spot attribute of the spot advertisement.

As provided herein, the primary advertiser may be dynamically paired with one or more spot advertisers to efficiently generate a combined advertisement. In an example, a combined advertisement generation component may generate the combined advertisement in real-time with little to no interaction with the primary advertiser and/or the spot advertiser. The combined advertisement may improve the marketing effectiveness of the primary advertisement and/or the spot advertisement by allowing complimentary advertisers pairings (e.g., primary advertisers and spot advertisers having corresponding attributes) to target the same consumers. Accordingly, a consumer with an interest in one of the advertisements (e.g., the primary advertisement and/or the spot advertisement) may develop an interest in the other advertisement within the combined advertisement. In another example, the combined advertisement may improve the marketing effectiveness of the primary advertisement and/or the spot advertisement by providing advertisements for multiple aspects of a business, consumer product, or service. For example, the primary advertisement may be for an online electronics retailer (e.g., a seller) and the spot advertisement may be for a new tablet (e.g., a product) that the online electronics retailer sells. Accordingly, the combined advertisement may improve marketing effectiveness by informing the consumer of a product and a retailer that carries the product.

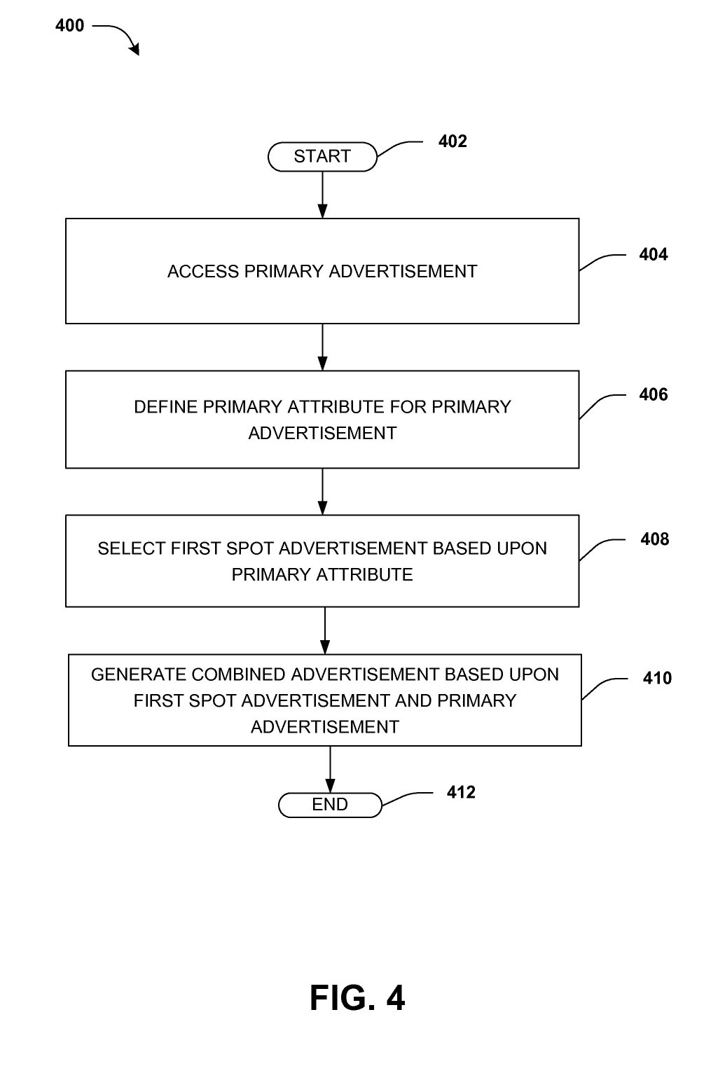

An embodiment for generating a combined advertisement is illustrated by an exemplary method 400 of FIG. 4. At 402, the method starts. At 404, a primary advertisement, associated with a primary advertiser, may be accessed. The primary advertisement may comprise a video advertisement, an interactive advertisement (e.g., Flash advertisements, GIF advertisements, etc.), an expanding advertisement (e.g., an advertisement that changes form such as, starting out as a static advertisement and then expanding to a full screen interactive video advertisement), an imagery advertisement (e.g., a static advertisement, a hyperlink advertisement, etc.), and/or any other type of advertisement. In an example, the primary advertiser may generate the primary advertisement as part of a primary advertisement campaign. The primary advertisement campaign may comprise creative advertisement schemes (e.g. designs, color schemes, formats, etc.), budget amounts, targeted demographic, and/or campaign goals (e.g. a cost per click (CPC) goal, a cost per action (CPA) goal, etc.). In an example, the primary advertiser may be a retailer (e.g., a department store, a supermarket, a warehouse retailer, an online retailer, etc.).

In an example, the primary advertisement may be associated with an advertisement template that provides a template/basis for generating the combined advertisement using the primary advertisement and one or more spot advertisements. The advertisement template may correspond to an advertisement template framework. The advertisement template framework may define a set of rules for the primary advertisement (e.g., a size rule, a visual rule, a formatting rule, a positioning rule, etc.) and/or spot advertisements. In an example, the primary advertiser may define the rules for the advertisement template framework through a user interface or API provided by a combination advertisement generation component.

At 406, a primary attribute may be defined for the primary advertisement. The primary attribute may comprise at least one of a targeting attribute (e.g., a targeted audiences for the primary advertisement), a budget attribute (e.g., a budget for a campaign, a cost per impression budget, a cost per click budget, a bid limit, etc.), a creative attribute (e.g., design, format, and/or location of the primary advertisement and/or spot advertisements within the combined advertisement), or an exclusionary attribute (e.g., products and/or suppliers with which the primary advertiser may not want to advertise). The targeting attribute may comprise at least one of a demographic attribute (e.g., age, gender, ethnicity, education, income, relationship status, housing, etc.), a product attribute (e.g., product class, such as a household product, an electronic product, a personal care product, etc.), a geographical attribute (e.g., a user location), a seller attribute, a manufacturer attribute, or a browser history attribute. In an example, the set of rules for the advertisement template framework may specify the primary attribute (e.g., a targeting attribute, an exclusionary attribute, etc.) for the primary advertisement.

At 408, a first spot advertisement associated with a first advertiser (e.g., a spot advertiser) may be selected based upon the first spot advertisement corresponding to the primary attribute of the primary advertisement. The selection of the first spot advertisement may comprise matching the primary attribute of the primary advertisement with a spot attribute of the first spot advertisement (e.g., a household goods seller having a household seller attribute may be matched with a household goods manufacturer having a household product attribute based upon the household seller attribute matching the household product attribute). The matching may comprise performing a similarity calculation between two or more attributes. In an example, the set of rules, contained within the advertisement template framework, may be utilized to determine whether the first spot advertisement qualifies for selection.

In an example, a second spot advertisement associated with a second advertiser (e.g., a second spot advertiser) may be selected based upon the second spot advertisement corresponding to the primary attribute of the primary advertisement and/or the spot attribute of the first spot advertisement. In an example, the spot attribute of the first spot advertisement may be incorporated into the set of rules for the advertisement template framework based upon the first spot advertisement being selected.

In an example, the selection of the first spot advertisement may be based upon an exclusionary attribute of the primary advertisement. The exclusionary attribute may comprise a rule defined by the primary advertiser. In an example, the first spot advertisement, but not the second spot advertisement, may be selected based upon the first spot advertisement satisfying the exclusionary attribute and the second spot advertisement not satisfying the exclusionary attribute. In an example, a primary advertiser, such as a tire manufacturer, may define a rule to exclude spot advertisements associated with competitor tire manufacturers. In another example, a primary advertiser, such as a toy store, may define a rule to exclude spot advertisements associated with R rated content (e.g., an R rated movie advertisement may be disqualified for combination with a primary advertisement of the toy store).

In an example, the selecting the first spot advertisement may comprise a bidding process (e.g., an auction). The bidding process may comprise an offline bidding process and/or an online bidding process (e.g., programmatic instantaneous auctions, etc.). The online bidding process may comprise real-time bidding (e.g., programmatic instantaneous bidding for advertisements in response to a server request for an advertisement, such as a website server that is to display a webpage comprising an advertisement opportunity). In an example, a first bid by the first advertiser for the first spot advertisement may exceed a second bid by a second advertiser for the second spot advertisement. Accordingly, the first spot advertisement may be selected but not the second spot advertisement in response to the first bid exceeding the second bid. In another example, when the first bid exceeds the second bid, but the second bid meets a threshold bid amount (e.g., a predetermined minimum bid amount), both the second spot advertisement and the first spot advertisement may be selected. Because the second spot advertisement was selected based upon meeting the threshold bid amount, the second spot advertisement may be assigned a less prominent position within the combined advertisement, displayed for a shorter period of time, and/or displayed at a lower frequency relative to the first spot advertisement (e.g., where the combined advertisement comprises a carousel through which one or more spot advertisements are displayed).

The bidding process may be initiated by a triggering event, such as a consumer requesting a website having an advertisement opportunity. In an example, an advertisement request, comprising a primary bid request, may be sent to an advertisement server (e.g., a demand-side platform, a supply-side platform, etc.) of the primary advertiser in response to the triggering event. The primary bid request may comprise a consumer attribute for the consumer visiting the website (e.g., demographic information, such as gender, age, income, etc., social media network information, location information, web browsing history information, webpage bookmark information, current webpage context information, etc.).

In response to receiving the primary bid request, the primary advertiser may submit a first bid for the advertisement opportunity of displaying the primary advertisement to the consumer (e.g., the first bid may be submitted by an automated bidding component based upon pre-entered bidding parameters). In response to the primary advertiser winning the action, a spot bid request may be sent to one or more spot advertisers, such as the first advertiser and/or the second advertiser. The spot bid request may comprise the primary attribute for the primary advertisement (e.g., an exclusionary attribute, a targeting attribute, etc.) and/or the consumer attribute for the consumer. Responsive to a first spot advertisement, of the first advertiser, corresponding to the primary attribute and/or the consumer attribute, a first bid by the first advertiser may be accepted for consideration. Responsive to a second spot advertisement, of the second advertiser, corresponding to the primary attribute and/or the consumer attribute, a second bid by the second advertiser may be accepted for consideration.

In an example, a spot advertiser may provide one or more bidding parameters that may be used for automatically adjusting a bid. The bidding parameters may comprise at least one of a keyword entered by the consumer (e.g., a bid may be increased for an advertisement, having a relatively high likelihood of resulting in a conversion, based upon the advertisement corresponding the keyword), a click history of the consumer, a time frame of the triggering event (e.g., a bid of a snow tire advertisement may be increased during the winter), a consumer access method (e.g., a first bid, for a mobile device advertisement opportunity, may be increased if consumers of the first advertiser historically make purchases via a mobile device).

In an example, the selected spot advertisements may be submitted to at least one of the primary advertiser and/or an advertisement host (e.g., a content provider) for approval. Upon approval, the combined advertisement may be generated.

At 410, a combined advertisement may be generated based upon the primary advertisement and the first spot advertisement. In an example, the generating the combined advertisement may comprise inserting the primary advertisement into a primary advertisement region of the combined advertisement and/or inserting the first spot advertisement into a secondary advertisement region of the combined advertisement. In an example, the template advertisement framework may be utilized to define the primary advertisement region and/or the secondary advertisement region.

In an example, the secondary advertisement region may comprise an advertisement carousel. The advertisement carousel may be configured to display one or more spot advertisements selected for combination with the primary advertisement. In an example, the advertisement carousel may be configured to sequentially display the first spot advertisement and then the second spot advertisement. In another example, the advertisement carousel may be configured to display a spot advertisement and at least a portion of another spot advertisement at any given visual state (e.g., allowing the consumer to fully view the first spot advertisement and partially view the second spot advertisement regardless of the position of the first spot advertisement in the advertisement carousel).

In an example, the advertisement carousel may be configured to rotate between displaying the spot advertisements. The rotating between displaying the first spot advertisement and the second spot advertisement may occur based upon a rotation triggering event. In an example, the rotation triggering event may comprise at least one of a page refresh event, a time expiration event, or a webpage interaction event (e.g., invoking a next button, mousing over a partially visible spot advertisement, a swipe gesture, etc.).

The combined advertisement may be provided to the consumer through a user interface displayed on at least one of a mobile device (e.g., a smartphone, a tablet, a smartwatch, etc.), a personal computer (e.g., a desktop, a laptop, etc.), a digital billboard, a video gaming device, or an advertisement platform (e.g., a television in a hotel lobby, or a digital kiosk in a mall). The combined advertisement may be included within a webpage, an application interface (e.g., a news application, a shopping application, a sports application, etc.), an email, a videogame, a recommendation, a push notification to a mobile device, etc. The combined advertisement may be displayed to the consumer in response to determining that the consumer corresponds to the primary attribute (e.g., if the primary attribute is a male gender attribute, then the combined advertisement may be displayed to a male consumer). In an example, a consumer may request to view a webpage. In response to the request, the primary advertisement may be determined as qualifying for inclusion within the webpage based upon the consumer attribute correspond to the primary attribute of the primary advertisement. The first spot advertisement may be selected in real-time to generate the combined advertisement for inclusion within the webpage that is to be provided to the consumer in response to the consumer requesting to view the webpage.

In an example, a consumer interest may be tracked based upon a consumer interaction with the primary advertisement and/or one or more spot advertisements combined with the primary advertisement (e.g., a conversion, a purchase, a view, a click, etc.). In an example, the consumer interest may be tracked based upon an interaction with at least one of the primary advertisement region or the secondary advertisement region. For example, eye movement (e.g., a camera may detect that the first consumer focused on the primary advertisement longer than the secondary advertisement), a graphical interaction tool (e.g., a cursor click), a tactile interaction (e.g., a touch gesture), etc. of the consumer may be tracked relative to the primary advertisement region and/or the secondary advertisement region.

At 412, the method ends.

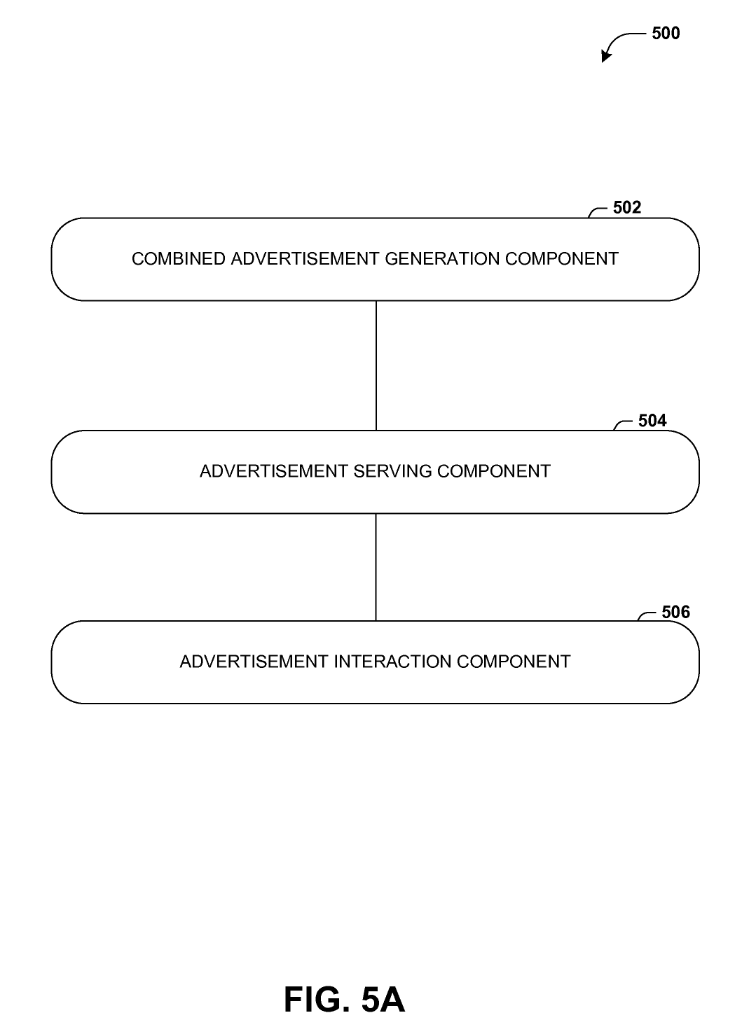

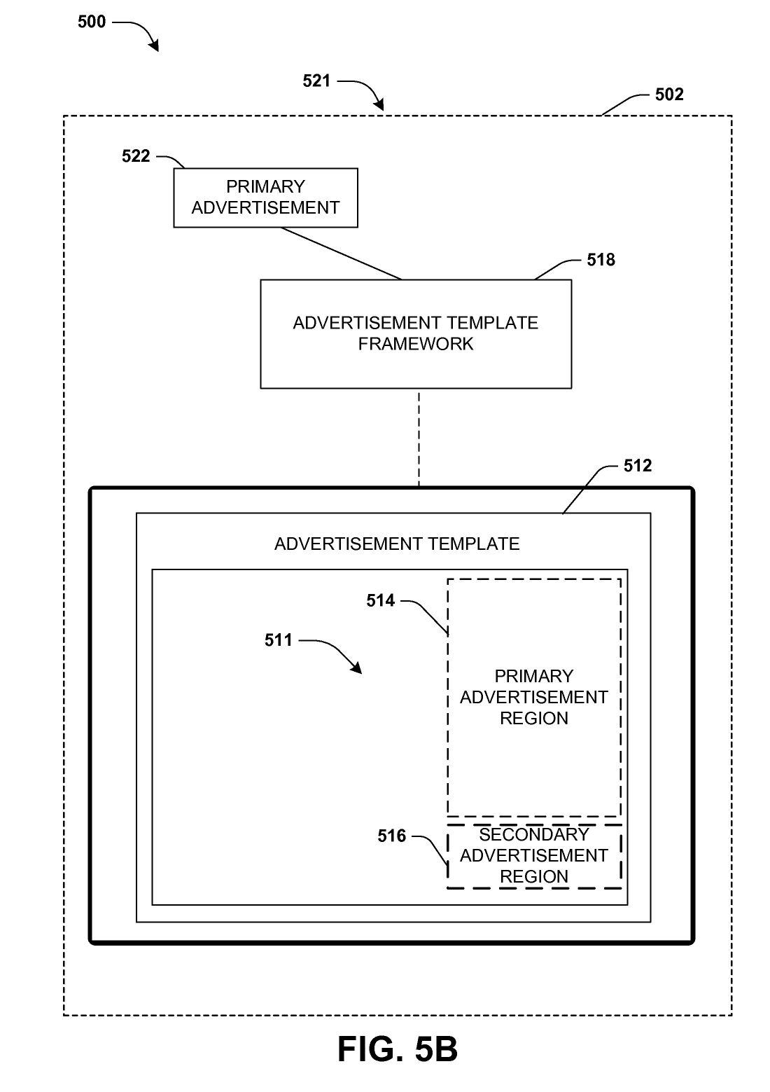

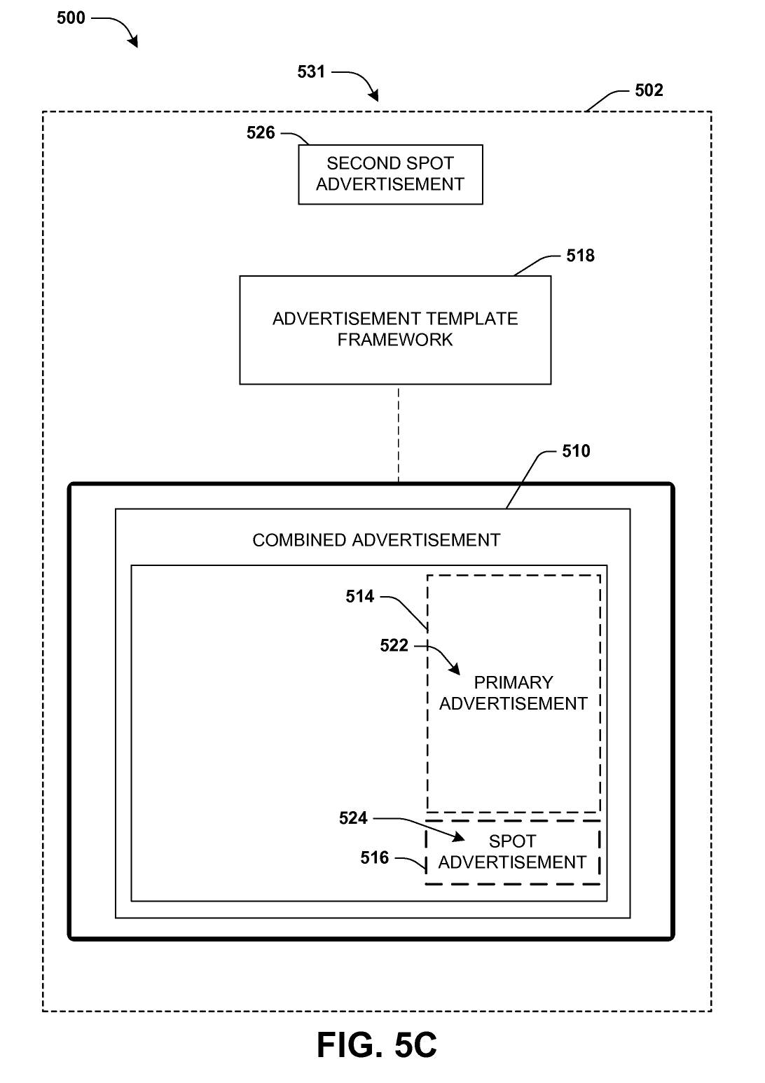

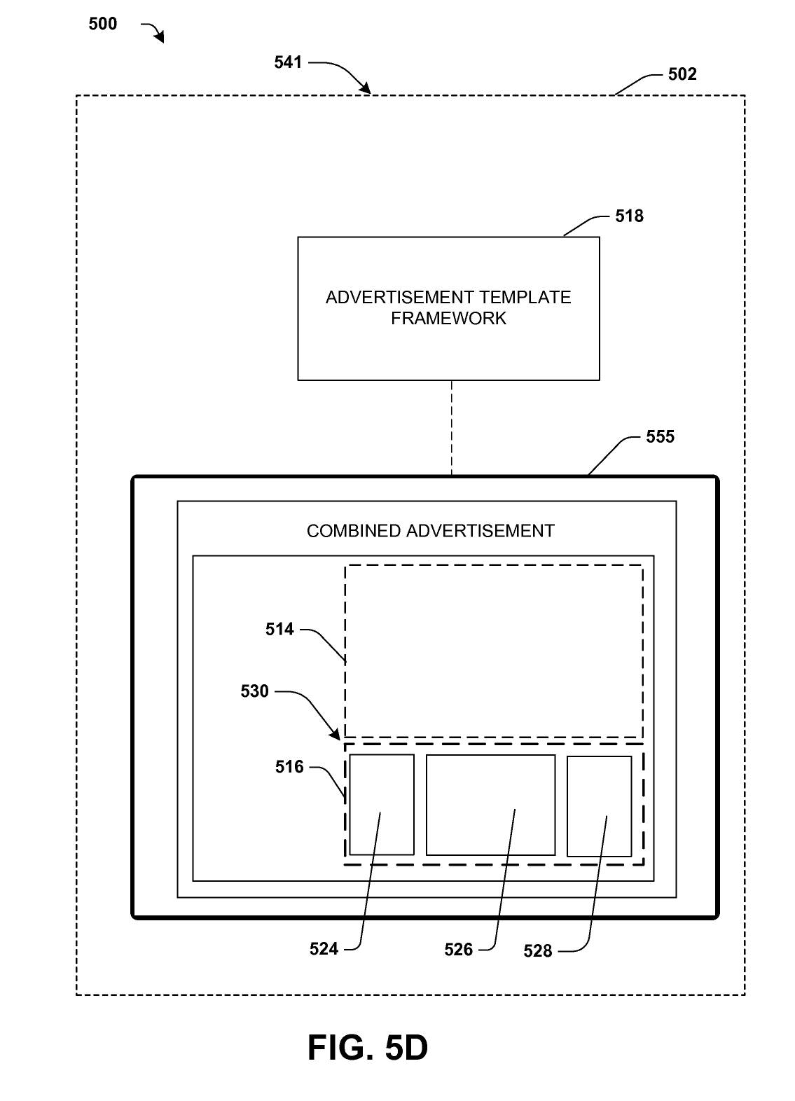

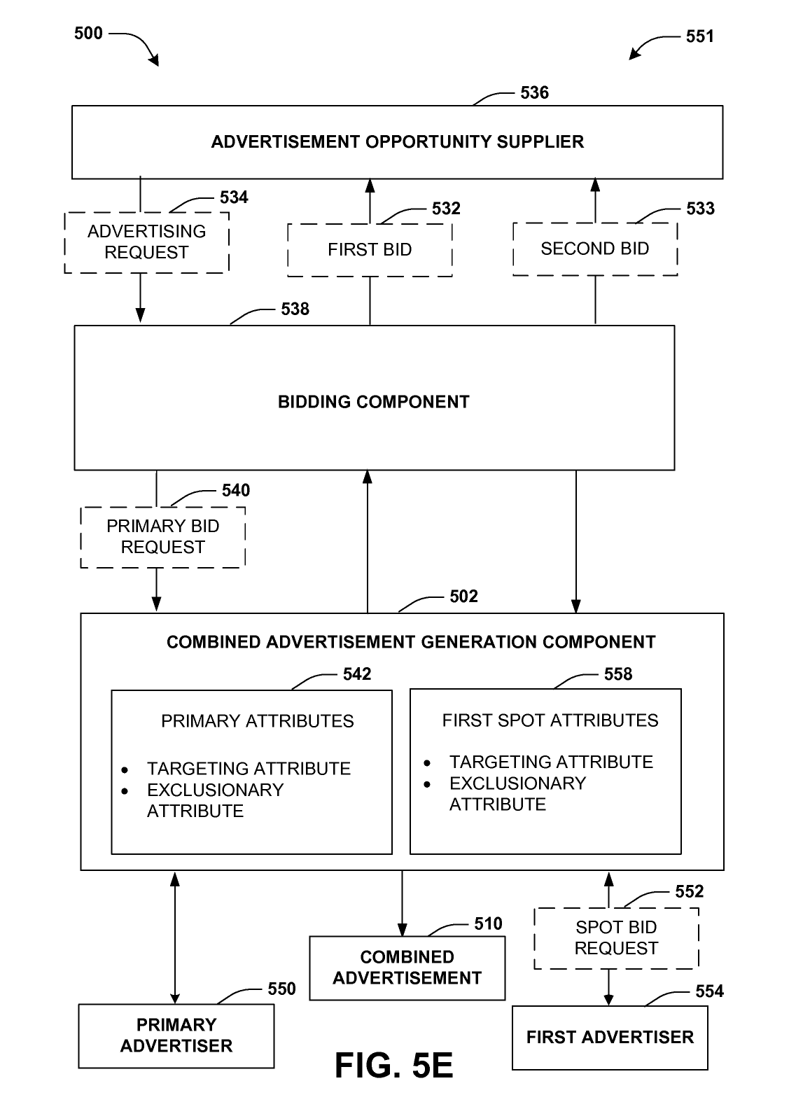

FIG. 5A illustrates an example of a system 500 for generating a combined advertisement. The system 500 may comprise a combined advertisement generation component 502, an advertisement serving component 504, and/or an advertisement interaction component 506. In an example, the combined advertisement generation component 502 may be configured to access (e.g., receive, generate, etc.) a primary advertisement associated with a primary advertiser. The combined advertisement generation component 502 may be configured to define a primary attribute for the primary advertisement, such as a targeting attribute, an exclusionary attribute, etc. The combined advertisement generation component 502 may be configured to select a first spot advertisement, associated with a first advertiser (e.g., a first spot advertiser), based upon the primary attribute for the primary advertisement. The combined advertisement generation component 502 may be configured to generate a combined advertisement based upon the first spot advertisement and the primary advertisement. In an example, the primary advertisement may be inserted into a primary advertisement region of the combined advertisement and the first spot advertisement may be inserted into a secondary advertisement region of the combined advertisement.

The advertisement serving component 504 may be configured to receive an advertisement request from a webpage accessed by a consumer having a consumer attribute. The advertisement serving component 504 may be configured to display the combined advertisement to the consumer responsive to the consumer attribute matching the primary attribute.

The advertisement interaction component 506 may be configured to track a consumer interest based upon a consumer interaction with at least one of a primary advertisement region or a secondary advertisement region.

FIGS. 5B-5E illustrate examples of the system 500 generating a combined advertisement 510 (e.g., combined advertisement 510 of FIGS. 5C-5E). FIG. 5B, illustrates an example 521 of the combined advertisement generation component 502 accessing a primary advertisement 522 corresponding to an advertisement template 512. The advertisement template 512 may be associated with an advertisement template framework 518. The advertisement template framework 518 may comprise a set of rules defined by the primary advertiser and/or an advertisement host (e.g., a content provider, a website owner, etc.). The set of rules may comprise one or more primary attributes for the primary advertisement 522. In an example, the set of rules may define a layout 511. The layout 511 may serve as a blueprint for accessing, generating, and/or formatting (e.g., visually constructing and/or laying out an advertisement) the primary advertisement 522, a spot advertisement 524, and/or the combined advertisement 510. In an example, the layout 511 may define a primary advertisement region 514 and/or a secondary advertisement region 516.

FIG. 5C illustrates an example 531 of the combined advertisement generation component 502 generating the combined advertisement 510 based upon the advertisement template framework 518. In an example, the advertisement template framework 518 may be utilized to determine whether the first spot advertisement 524 qualifies for inclusion within the combined advertisement 510 (e.g., a primary clothing retailer may define a rule, within the advertisement template framework 518, to exclude spot advertisements associated with local competitor clothing retailers). For example, a second spot advertisement 526, for a local competitor clothing retailer located 2 miles from the primary clothing retailer, may not be selected based upon the rule. In response to the combined advertisement generation component 502 determining that the first spot advertisement 524 qualifies (e.g., a non-competitive shoe store), the primary advertisement 522 may be inserted into the primary advertisement region 514 and the first spot advertisement 524 may be inserted into the secondary advertisement region 516 to generate the combined advertisement 510.

FIG. 5D, illustrates an example 541 of the combined advertisement generation component 502 configured to generate a second combined advertisement 555 comprising the first spot advertisement 524, the second spot advertisement 526 and/or a third spot advertisement 528. In an example, the secondary advertisement region 516 may comprise an advertisement carousel 530 configured to sequentially transition between displaying the first spot advertisement 524, the second spot advertisement 526, and the third spot advertisement 528. For example, the advertisement carousel 530 may be configured to rotate between displaying the first spot advertisement 524, the second spot advertisement 526, and/or the third spot advertisement 528 based upon a rotation triggering event, such as a page refresh event, a time expiration event, or a webpage interaction event (e.g., a swipe gesture).

FIG. 5E illustrates an example 551 of submitting bids on behalf of advertisers. A bidding component 538 may receive an advertising request 534 from an advertisement opportunity supplier 536. The advertising request 534 may request one or more bids for one or more advertising opportunities, such as on a webpage. The combined advertisement generation component 502 may evaluate a set of advertising opportunity based upon one or more primary attributes 542 of a primary advertisement, of a primary advertiser 550, to determine a target advertising opportunity. For example, the combined advertisement generation component 502 may identify an advertising opportunity on a used car website as the target advertising opportunity based upon a car seller attribute of the primary advertisement.

The combined advertisement generation component 502 may receive a primary bid request 540 from the bidding component 538 for the target advertising opportunity. The primary bid request 540 may comprise one or more attributes of the target advertising opportunity. The primary advertiser 550 may submit a first bid 532, on behalf of the primary advertiser 550 for the primary advertisement, for the target advertising opportunity. In response to the primary advertiser 550 winning the auction, a spot bid request 552 may be sent to a first advertiser 554 (e.g., a spot advertiser). The spot bid request 552 may comprise one or more primary attributes 542 for the primary advertisement and/or one or more attributes of the target advertising opportunity. Responsive to first spot attributes 558, of a first spot advertisement associated with the first advertiser 554, corresponding to the primary attributes 542, the first advertiser 554 may instruct the bidding component 538 to submit a second bid 533 to the advertisement opportunity supplier 536. The combined advertisement generation component 502 may generate the combined advertisement 510 based upon the primary advertisement and the first spot advertisement.

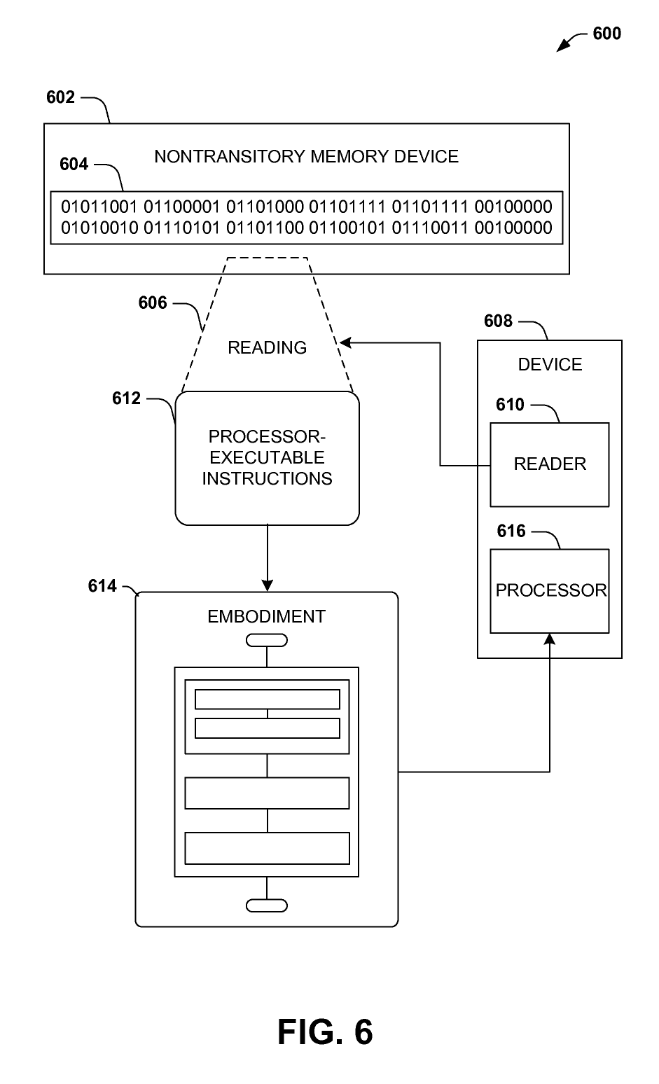

FIG. 6 is an illustration of a scenario 600 involving an exemplary nontransitory memory device 602. The nontransitory memory device 602 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The exemplary nontransitory memory device 602 stores computer-readable data 604 that, when subjected to reading 606 by a reader 610 of a device 608 (e.g., a read head of a hard disk drive, or a read operation invoked on a solid-state storage device), express processor-executable instructions 612. In an example, the processor-executable instructions, when executed on a processor 616 of the device 608, are configured to perform a method, such as at least some of the exemplary method 400 of FIG. 4, for example. In an example, the processor-executable instructions, when executed on the processor 616 of the device 608, are configured to implement a system, such as at least some of system 500 of FIGS. 5A-5E, for example.

3. Usage of Terms

As used in this application, “component,” “module,” “system,” “interface,” and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller may be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method for generating a combined advertisement, comprising:
accessing a primary advertisement associated with a primary advertiser;
defining a primary attribute for the primary advertisement;
selecting a first spot advertisement, associated with a first advertiser, based upon the primary attribute; and
generating a combined advertisement based upon the first spot advertisement and the primary advertisement.

2. The method of claim 1, the generating the combined advertisement comprising:
inserting the primary advertisement into a primary advertisement region of the combined advertisement; and
inserting the first spot advertisement into a secondary advertisement region of the combined advertisement.

3. The method of claim 1, the primary attribute comprising at least one of:
a demographic attribute, a budget attribute, a product attribute, a geographical attribute, a seller attribute, a manufacture attribute, an exclusionary attribute, a browser history attribute, or a creative attribute.

4. The method of claim 1, comprising:
responsive to determining that a consumer corresponds to the primary attribute, displaying the combined advertisement to the consumer.

5. The method of claim 1, the primary attribute comprising an exclusionary attribute, and the selecting the first spot advertisement comprising:
selecting the first spot advertisement, but not a second spot advertisement, based upon the first spot advertisement satisfying the exclusionary attribute and the second spot advertisement not satisfying the exclusionary attribute.

6. The method of claim 1, comprising:
responsive to a consumer requesting a webpage:
determining that the primary advertisement qualifies for inclusion within the webpage; and
selecting the first spot advertisement in real-time to generate the combined advertisement for inclusion within the webpage that is to be provided to the consumer.

7. The method of claim 1, the selecting comprising:
submitting the first spot advertisement to at least one of the primary advertiser or an advertisement host for approval.

8. The method of claim 1, the selecting comprising:
responsive to a first bid by the first advertiser for the first spot advertisement exceeding a second bid by a second advertiser for a second spot advertisement, selecting the first spot advertisement but not the second spot advertisement.

9. The method of claim 2, comprising:
tracking a consumer interest based upon a consumer interaction with at least one of the primary advertisement region or the secondary advertisement region.

10. The method of claim 9, the tracking the consumer interest comprising at least one of:
tracking an eye movement of a consumer relative to at least one of the primary advertisement region or the secondary advertisement region;
tracking a graphical interaction tool of the consumer relative to at least one of the primary advertisement region or the secondary advertisement region;
tracking a tactile interaction of the consumer relative to at least one of the primary advertisement region or the secondary advertisement region; or
tracking a gesture of the consumer relative to at least one of the primary advertisement region or the secondary advertisement region.

11. The method of claim 1, comprising:
selecting a second spot advertisement based upon at least one of the second spot advertisement corresponding to the primary attribute of the primary advertisement or the second spot advertisement corresponding to a spot attribute of the first spot advertisement; and
generating the combined advertisement based upon the primary advertisement, the first spot advertisement, and the second spot advertisement.

12. The method of claim 2, the secondary advertisement region comprising an advertisement carousel configured to display the first spot advertisement and a second spot advertisement.

13. The method of claim 1, comprising:
receiving an advertisement template framework defining a set of rules used for spot advertisement selection, the set of rules comprising the primary attribute; and
utilizing the advertisement template framework to determine whether the first spot advertisement qualifies for selection.

14. The method of claim 12, comprising:
responsive to a rotation triggering event, rotating the advertisement carousel from displaying the first spot advertisement to displaying the second spot advertisement.

15. The method of claim 14, the rotation triggering event comprising at least one of:
a page refresh event, a time limit expiration event, or a webpage interaction event.

16. A computer readable medium comprising instructions which when executed perform a method for generating a combined advertisement, comprising:
accessing a primary advertisement associated with a primary advertiser;
defining a primary attribute for the primary advertisement;
selecting a first spot advertisement, associated with a first advertiser, based upon the primary attribute, the first spot advertisement comprising a spot attribute;
selecting a second spot advertisement, associated with a second advertiser, based upon at least one of the primary attribute or the spot attribute; and
generating a combined advertisement based upon the primary advertisement, the first spot advertisement, and the second spot advertisement.

17. The method of claim 16, comprising:
submitting the first spot advertisement and the second spot advertisement to at least one of the primary advertiser or an advertisement host for approval.

18. A system for generating a combined advertisement, comprising:
a combined advertisement generation component configured to:
access a primary advertisement associated with a primary advertiser;
define a primary attribute for the primary advertisement;
select a first spot advertisement, associated with a first advertiser, based upon the primary attribute; and
generate a combined advertisement based upon the first spot advertisement and the primary advertisement.

19. The system of claim 18, comprising:
an advertisement serving component configured to:
receive an advertisement request from a webpage accessed by a consumer having a consumer attribute; and
display the combined advertisement to the consumer responsive to the consumer attribute matching the primary attribute.

20. The system of claim 18, the primary advertisement comprising a primary advertisement region within which the primary advertisement is inserted and a secondary advertisement region within which the first spot advertisement is inserted, the system comprising:
an advertisement interaction component configured to:
track a consumer interest based upon a consumer interaction with at least one of the primary advertisement region or the secondary advertisement region.
